(19) United States
(12) Patent Application Publication
(10) Pub. No.: US 2013/0218643 A1
(43) Pub. Date: Aug. 22, 2013

(54) METHOD TO ASSESS PROGRAM COMPLIANCE

(71) Applicant: METAPOWER, INC., (US)

(72) Inventors: KENNETH R. ALLEN, VANCOUVER, WA (US); JOHN PROUTY, PORTLAND, OR (US); CARL C. GREEN, SPOKANE, WA (US)

(73) Assignee: METAPOWER, INC., VANCOUVER, WA (US)

(21) Appl. No.: 13/767,431

(22) Filed: Feb. 14, 2013

Related U.S. Application Data
(60) Provisional application No. 61/601,466, filed on Feb. 21, 2012.

(51) Int. Cl. G06Q 30/00

(52) U.S. Cl. CPC G06Q 30/018
USPC 705/7.36

(57) ABSTRACT

A system including a computer can be used to determine if a company is in compliance with a business program. Requirements are identified for the business program, which are mapped to asset types. Each requirement is associated with a phase of the business program. Structural and cultural dimensions are identified. For each combination of requirement/asset in structural and cultural dimensions in a given phase, a maturity level can be determined, which can then be used to determine if the company is in compliance with the business program.

### RELATED APPLICATION DATA

This application claims the benefit of U.S. Provisional Patent Application Ser. No. 61/601,466, filed Feb. 21, 2012, which is hereby incorporated by reference.

### FIELD OF THE INVENTION

This invention pertains to a method for determining whether a company is in compliance with a business program.

### BACKGROUND OF THE INVENTION

The concept of the business program is nothing new. Many businesses have “championed” various programs, such as safety programs or reducing carbon emissions, to show how concerned they are with various aspects of life. The idea of the business program is so well known that it is frequently mocked. For example, the introduction to FOX's long-running animated hit, The Simpsons, includes a segment where Homer Simpson is handling a rod of what is presumed to be plutonium, while in the background Lenny Leonard is standing on a ladder, updating a sign that reflects how many days have passed since the last accident has occurred at the nuclear power plant. As the bell rings to announce the end of the shift, Lenny loses his balance and falls down, showing that the counter needs to be reset back to zero.

But while it is easy for a company to state that they are interested in implementing a business program, making the business program work the way it is intended to work is not so trivial a matter. For example, a company can invest many thousands of dollars in new, safer equipment. But if the safety features of the new equipment are bypassed, the company has made little progress in increasing workplace safety. Similarly, if the new equipment has operational limits (e.g., an upper bound on the operating temperature of the equipment) which are ignored, the new equipment is not necessarily any safer than the old equipment. In fact, workplace safety might have been decreased by purchasing the new equipment, as the hazards associated with ignoring the operating instructions might be worse than those of the old equipment.

The present invention addresses these and other problems associated with the prior art.

### SUMMARY OF THE INVENTION

Embodiments of the invention include identifying requirements that need to be implemented for a business program. The requirements of the business program can be evidenced in various types of assets. Maturity levels can be determined for asset types with respect to the requirements, in both structural and cultural dimensions. The maturity levels can be evaluated, to determine if the company is in compliance with the business program.

The foregoing and other features, objects, and advantages of the invention will become more readily apparent from the following detailed description, which proceeds with reference to the accompanying drawings.

### BRIEF DESCRIPTION OF THE DRAWINGS

FIG. 1 shows different types of assets in which the requirements of a business program are implemented.

FIG. 2 shows a computer system to determine whether a company is in compliance with a business program, according to an embodiment of the invention.

FIG. 3 shows the relationship among a business program, requirements, asset types, and assets in the system of FIG. 2.

FIG. 4 shows different structural and cultural dimensions, along with different maturity levels, that can be used in determining whether the company is in compliance with the business program in the system of FIG. 2.

FIG. 5 shows different phases of implementing the requirements of a business program in the system of FIG. 2.

FIG. 6 shows the maturity determiner of FIG. 2 assigning a score to a requirement and an asset type in which a requirement is implemented for a specific dimension.

FIG. 7 shows the assessor of FIG. 2 using maturity scores of FIG. 6 to determine if a company is in compliance with a business program.

FIG. 8 shows a flowchart of a procedure to determine if a company is in compliance with a business program, according to an embodiment of the invention.

FIG. 9 shows details of how the system of FIG. 2 can determine if a company is in compliance with a business program in the flowchart of FIG. 8.

### DETAILED DESCRIPTION OF THE PREFERRED EMBODIMENT

Before getting into the specifics of how embodiments of the invention can be used to determine whether a company is in compliance with a business program (sometimes just called a “program”), it is helpful to understand some basic concepts. First, a business program is the business logic needed to achieve a sustainable outcome. A business program is separate to business processes implemented by a company. A business program can be evidenced in asset types (and assets), and an individual asset type (and asset) can provide evidence of multiple business programs.

Second, to implement a business program, a company must determine the requirements of the business program, and then identify what asset types will need to be acquired/changed to achieve the requirements of the business program. From an individual company's perspective, “implementing a business program” means identifying the tasks the company will need to take to implement the business program; but before a company can carry out any tasks to implement a business program, the requirements of the business program need to be determined.

An individual business program—for example, a safety program—can apply to any number of different companies. The requirements of the business program are the same regardless of the company implementing the business program: it is only the specific elements of implementation that vary between companies. (The term “implement” means “to attempt to put into place”: as discussed below, there is generally no expectation that success will be immediately achieved and the business program will be immediately functioning.) The business program requirements are specific to a particular business program, in that each business program will have different requirements needed to implement the business program. There can be any number of requirements to implement a business program. For example, it is reasonable for there to be hundreds of different requirements needed to implement a particular business program.

Normally, it is sufficient if a company implements enough of the requirements for a business program to be considered to comply with the business program. But a person of ordinary skill in the art will recognize that it is possible that a company can satisfy additional requirements for the business program beyond the core set of requirements to implement the business program. A company might desire to be “proactive” or “ahead of the curve” in implementing a particular business program. For example, a company might desire to be looking for ways to improve its safety record beyond those required by a safety business program.

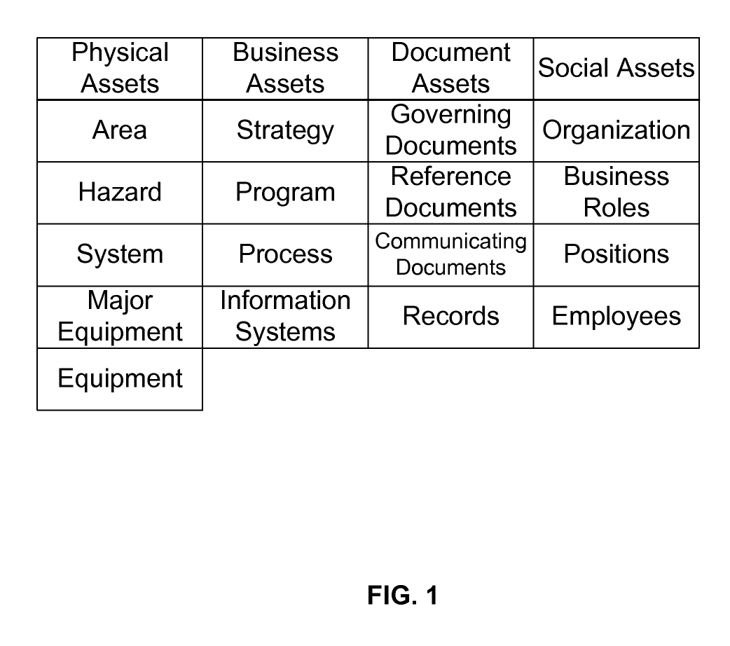

Third, implementing the requirements of the business program depends on various types of assets. For example, to satisfy the requirements of a business program, a company might have to acquire new equipment, draft new policies and procedures, and train personnel. Each of these elements—equipment, policies and procedures, and personnel—is a type of asset. Implementing a requirement of a business program often involves multiple asset types: that is, it is not unusual for a single requirement to involve multiple assets of different types. Similarly, it would not be unusual for a single asset type to provide evidence regarding multiple requirements of the business program. Thus, there is a many-to-many relationship between requirements and asset types. The various asset types, grouped into categories, are shown in FIG. 1 and in Table 1:

TABLE 1
Asset Categories and Types
Physical Assets

| | |
|---|---|
| System | Physical collections of hardware organized to |
| | produce a product or result |
| Major | One or more physical collections of the |
| Equipment | significant hardware that makes up the |
| | primary functions of a system |
| Equipment | Individual pieces of hardware that make up |
| | the plant or facility (Equipment has a location |
| | in the plant or facility and should be |
| | distinguished from Parts, which are |
| | components of Equipment that can be |
| | replaced or maintained) |
| Area | Physical space in a plant or facility that has |
| | recognizable boundaries and has been named |
| Hazard | Physical assets that have be identified and |
| | known to contain hazardous materials or |
| | energy |

Business Assets

| | |
|---|---|
| Strategy | A Systematic Evaluation of an enterprise's |
| | strengths, weaknesses, threats, and |
| | opportunities, as well as an articulation of |
| | how the enterprise exploits/mitigates these |
| | strengths, weaknesses, threats, and |
| | opportunities in order to achieve specifically |
| | stated business goals and objectives |
| Program | A series of logical activities needed to |
| | achieve specific business goals and |
| | objectives. |
| Process | A series of steps or transactions, performed |
| | by asset types that transform a business |
| | element from one state to another |
| Information | Computer applications deployed to support |
| Systems | other Business Assets |
| (Tools) | |

Document Assets (either paper or electronic)

| | |
|---|---|
| Governing | Organized documents that provide guidance |
| Documents | instruction or direction to employees |
| Reference | Organized text and graphics that record |
| Documents | information about the design and physical |
| | configuration of Systems Equipment Areas |
| | and Business Programs and Processes |
| Communication | Organized graphics, videos, publications, etc. |
| Docs | that communicate messages to others |
| Records | Organized text and graphics that record |
| | information about the execution of business |
| | process steps or transactions |

Social Assets

| | |
|---|---|
| Organization | A collection of Positions arranged to manage |
| | and direct the employees who fill those |
| | positions to accomplish a mission |
| Business | A logical collection of activities and |
| Role | responsibilities associated with a specific |
| | business process |
| Position | A collection of roles assigned to a specific |
| | location in the Organizational arrangement |
| | designed to accomplish a business function, |
| | based on an industry-defined collection of |
| | skills |
| Employee | A person who is or can be assigned to one or |
| | more positions |

Table 1 represents one way to divide assets into categories and types. But a person skilled in the art will recognize that there are other ways in which to divide assets into categories and types, and that embodiments of the invention are applicable to other asset categories and types.

Fourth, it would be nice if it would be possible to implement a business program at a moment's notice—for example, to make all the needed changes needed overnight, so that when the employees arrive the next morning the program is fully implemented. But in practice implementing a business program takes time. Thus, implementing a business program occurs in stages, termed “phases” below. In general, there are four phases in implementing any requirements of a business program. These phases are shown below in Table 2:

TABLE 2
Phases

| Phase | Description |
|---|---|
| Foundational | These Requirements become the foundational |
| | building blocks that will support higher-level |
| | requirements. Once these Foundational |
| | Requirements are mastered, the organization |
| | is prepared to successfully approach the |
| | higher-level tasks associated with the |
| | Standard Requirements. |
| Standard | These Requirements reflect tasks that build |
| | on the performance mastered at the |
| | Foundational level and prepare the |
| | organization to successfully approach the |
| | Advanced Requirements. |
| Advanced | These Requirements reflect tasks that build |
| | on the performance mastered at the Standard |
| | level and prepare the organization to |
| | successfully approach the Optimal |
| | Requirements. |
| Optimal | These Requirements reflect tasks that build |
| | on the performance mastered at the |
| | Advanced level and prepare the organization |
| | to successfully implement Optimal |
| | Requirements, which, once mastered, will |
| | position the organization as a world-class |
| | PSM performer. |

Table 2 represents one way to divide a business program into phases. But a person skilled in the art will recognize that there are other ways in which to divide a business program into phases, and that embodiments of the invention are applicable to other phases.

Although Table 2 shows four phases, a person of ordinary skill in the art will recognize that these phases can be subdivided, or described using different terminology, without changing the overall implementation of requirements. Embodiments of the invention cover other organizations of the phases. In a similar manner, the use of the labels “Foundational”, “Standard”, “Advanced”, and “Optimal” are merely labels. Embodiments of the claimed invention are intended to include phases of a business program, regardless of the specific label given to a phase.

The Foundational phase of requirements implementation covers establishing the underlying elements needed to begin a business program. For example, the Foundational phase can include acquiring new equipment needed for a safety program, or implementing a reporting system for workplace safety issues that need to be addressed.

The Standard phase of requirements implementation covers the more basic elements needed beyond the Foundational phase. For example, once a reporting system is put in place for safety problems, resolutions for reported safety problems will need to be determined. Determining how to resolve reported problems occurs during the Standard phase.

The Advanced phase of requirements implementation covers the more advanced issues relating to the requirements. For example, once the immediate problem of resolving a safety problem has been handled, a team can analyze what caused the safety problem in the first place, so that the same safety problem will not recur.

The Optimal phase of requirements implementation covers advances in the how the business program is implemented. For example, a team can look for trends in reported safety problems, and attempt to predict safety problems that have not yet occurred, in an effort to preemptively address these safety problems. The Optimal phase can cove things that go beyond the normal implementation of the business program.

Requirements are associated with a specific phase of the business program. That is, given an individual requirement for a business program, that requirement is associated with only one phase of the business program.

Fifth, most business programs only look at the structural elements needed to implement the business program. For example, most companies implementing safety programs look only at the physical aspects needed to make the business program succeed: new equipment that is safer to use, systems for reporting safety concerns, and so on. But there are cultural aspects as well, that are usually ignored. For example, if employees bypass the safety features—whether because they are instructed to do so by their managers or because they think the newer equipment is harder to use than the older equipment—the new equipment is meaningless. In one embodiment of the invention, there are five different dimensions that need to be considered to determine whether a company is actually complying with a business program, or which the physical equipment constitutes only one dimension. These dimensions are shown in Table 3:

TABLE 3
Dimensions

| Dimension | Meaning |
|---|---|
| Completeness | The physical elements needed to implement |
| of Structure | the business program |
| Response to | How personnel feel about being required to |
| Structure | implement the physical elements of the |
| | business program |
| Response to | How personnel view their role in enforcing |
| Peers | the requirements of the business program |
| Response to | How personnel compare their compliance in |
| the External | implementing the business program with |
| | external companies and industries |
| Response to | How personnel feel about how management |
| Leadership | is performing their role in implementing the |
| | business program |

Table 3 represents one way to identify dimensions of a business program. But a person skilled in the art will recognize that there are other ways in which to identify dimensions of a business program, and that embodiments of the invention are applicable to other dimensional organizations.

For a company to be in compliance with a business program, a company should be in compliance within each of the various dimensions: satisfying structure without the various cultural dimensions (Structural Response, Response to Peers, Response to the External, and Response to Leadership) does not truly implement a business program.

Sixth, as discussed above, a business program is the same without regard to the company implementing the business program, or even the industry in which the company practices. For example, a workplace safety program for a nuclear power plant is the same as a workplace safety program for a woodworking shop. The business program itself, its requirements, and the types of assets used to implement the business program, are consistent across companies. Only the specific assets used by the company to implement the requirements will vary with the company. Obviously, then, it is important to know what assets are responsible for implementing various requirements of a business program. With companies potentially having thousands of employees, tens of thousands of pieces of equipment, and hundreds of thousands (if not millions) of documents, examining every asset to find specific assets responsible for implementing a requirement of a business program would be overly burdensome. But while assets are specific to the company, asset types are consistent across multiple companies and industries. Thus, even though descriptions of embodiments of the invention might be made with reference to a particular industry, a person of ordinary skill in the art will recognize that the program is independent of the industry, and the descriptions can apply to any company in any industry implementing that particular program.

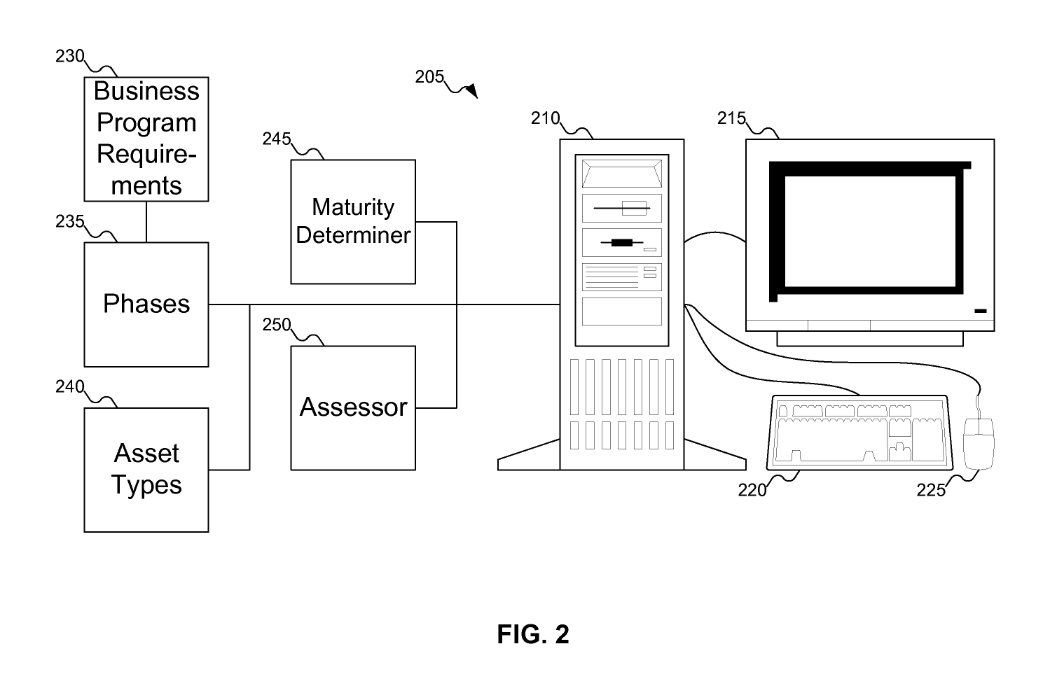

Turning now to embodiments of the claimed invention, FIG. 2 shows a computer system to determine whether a company is in compliance with a business program. In FIG. 2, computer system 205 is shown. Computer system 205 is shown as including computer 210, monitor 215, keyboard 220, and mouse 225. A person skilled in the art will recognize that other components may be included with computer system 205: for example, other input/output devices, such as a printer. In addition, FIG. 2 computer system 205 may include conventional internal components not shown in FIG. 2: for example, a central processing unit, memory, etc. Although not shown in FIG. 2, a person skilled in the art will recognize that computer system 205 may interact with other computer systems, either directly or over a network (not shown) of any type. Finally, although FIG. 2 shows computer system 205 as a conventional desktop computer, a person skilled in the art will recognize that computer system 205 may be any type of machine or computing device capable of providing the services attributed herein to computer system 205, including, for example, a laptop computer, a personal digital assistant (PDA), or a cellular telephone. In addition, computer system 205 can be implemented as a server, which is accessed from a secondary machine, which could be another computer or a dumb terminal, among other possibilities.

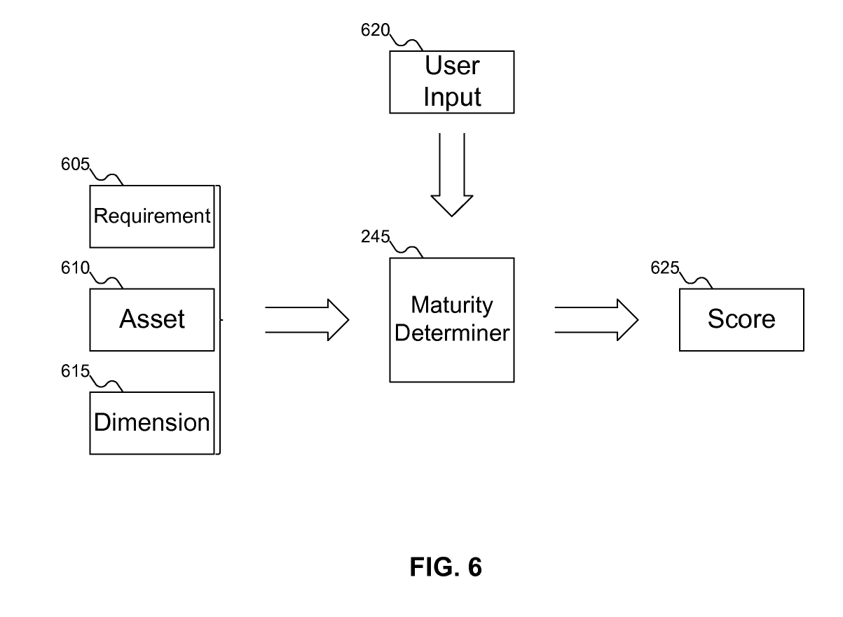

Computer system 205 includes set of requirements 230, phases 235, asset types 240, maturity determiner 245, and assessor 250. Set of requirements 230, phases 235, and asset types 240 are discussed above. Maturity determiner 245 determines, for a particular requirement, asset type, and dimension (structural or cultural), a maturity level. Maturity determiner 245 does not operate at a high level, but rather looks at specific aspects of the implementation of the business program, to see how mature those individual aspects are. Maturity determiner is discussed further with reference to FIG. 6 below.

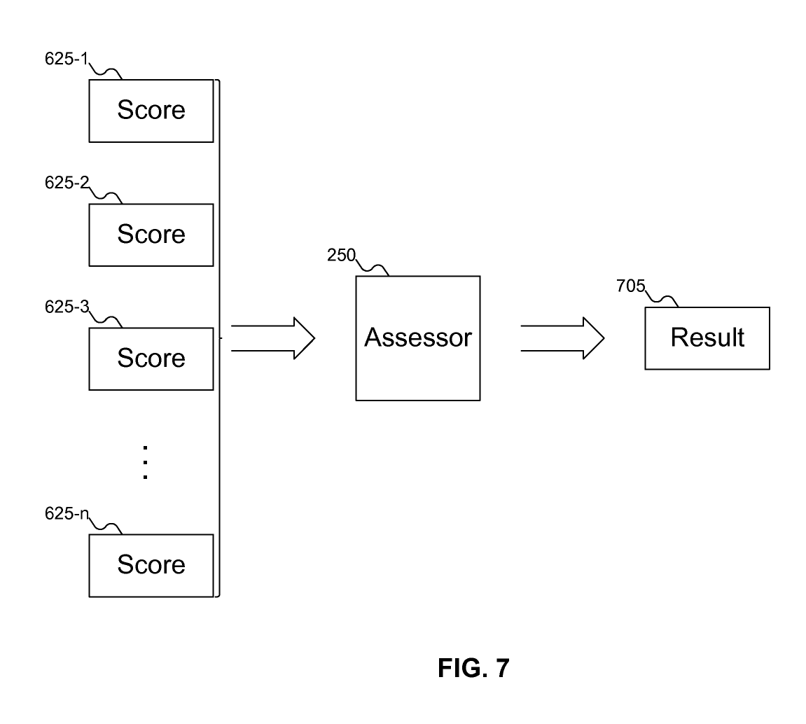

Assessor 250 can assess the overall compliance of the business program. Assessor 250 can take the individual determinations of maturity determiner 245 and combine them to determine whether the company as a whole is in compliance with the business program, or a simpler formulation can be used: for example, that compliance requires the implementation of the business program to have achieved a sufficient degree of maturity in the Competent phase of implementation. Because assessor 250 operates by taking a plurality of individual determinations and combines them to produce an analysis of the overall combination, it is also possible for assessor 250 to assess subsets of the overall business program. For example assessor 250 can assess the maturity of a requirement, a phase, an asset type, or a dimension (structural or cultural) among other possibilities. Assessor 250 is discussed further below with reference to FIG. 7.

As discussed above, the requirements (which can be associated with a specific phase of implementation of the business program) can implicate various asset types. For example, a requirement in a safety program might require the modification of particular pieces of machinery (physical assets) to make them safer, new policies (document assets) describing plans to prepare for various emergency situations, and employee training (social assets) in handling emergency situations. Similarly, for a given asset type such as equipment, there can be multiple pieces of equipment that are affected by the implementation of the business program requirement.

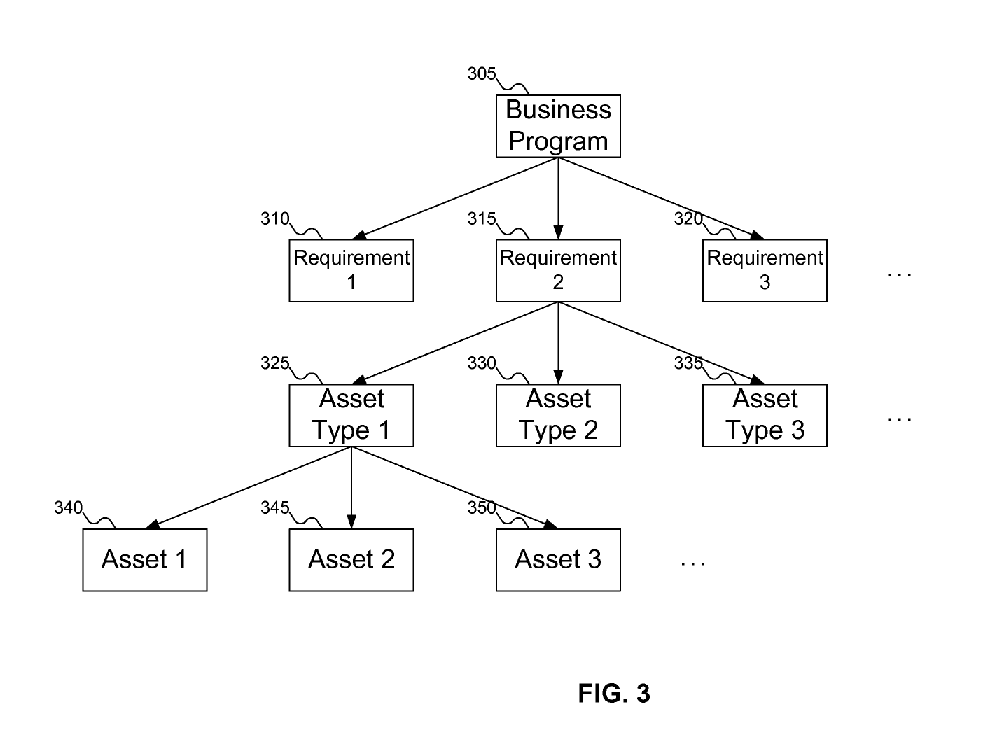

FIG. 3 reflects this relationship among requirements, asset types, and assets. As shown in FIG. 3, business program 305 can involve requirements, such as requirements 310, 315, and 320. An individual requirement, such as requirement 315, can implicate multiple assets types 325, 330, and 335: that is, asset types 325, 330, and 335 can provide evidence of requirement 315. Further, asset type 325 can implicate assets 340, 345, and 350. While FIG. 3 shows three requirements in business program 305, three asset types implicated by requirement 315, and three assets implicated by asset type 325, a person of ordinary skill in the art will recognize that a business program can involve any number of requirements, a given requirement can implicate any number of asset types, and a single asset type can implicate any number of assets.

While FIG. 3 shows a “tree” involving a business program, requirements, asset types, and assets, a person of ordinary skill in the art will recognize that the various “branches” of the tree will usually cross. For example, a single asset type can provide evidence of any number of requirements. Thus, the relationships shown in FIG. 3 are a not a “tree” in the mathematical sense of that term. And while a particular asset (e.g., a specific machine, or document) has only one asset type, because that asset type can provide evidence of many different requirements, it is possible that a single asset can be used to provide evidence of a particular requirement.

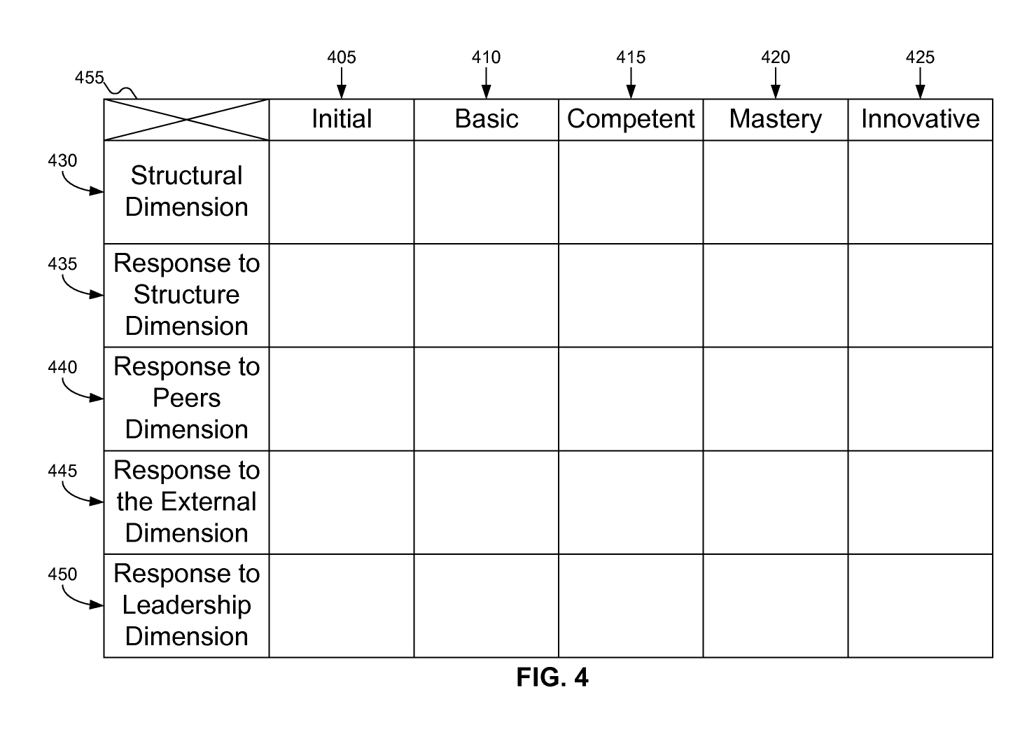

As discussed above, there are various different dimensions in the implementation of a business program. FIG. 4 shows different structural and cultural dimensions, along with different maturity levels, that can be used in determining whether the company is in compliance with the business program in the system of FIG. 2. FIG. 4 shows the five structural and cultural dimensions described above. For each structural and cultural dimension, there are five different possible maturity levels. These different maturity levels are shown below in Table 4:

TABLE 4
Maturity Levels

| Maturity Level | Description |
|---|---|
| Initial (405) | Initial decision to change has been made; first |
| | steps being taken; compliance is externally |
| | driven |
| Basic (410) | Externally driven change is in process; |
| | practice and fine tuning are needed to |
| | improve inconsistent success |
| Competent (415) | Externally driven changes are up and |
| | running; clear expectations established; new |
| | status-quo developing; success is consistent |
| Mastery (420) | Changes internalized by individuals; changes |
| | “make sense”, are “owned”, and have been |
| | mastered |
| Innovative (425) | People proactively collaborate to innovate |
| | improvement, creating industry |
| | leadership/“expert” status |

Table 4 represents one way to define maturity levels. But a person skilled in the art will recognize that there are other ways in which to define maturity levels, and that embodiments of the invention are applicable to other maturity level organizations.

While maturity levels can be determined for individual requirements, asset types/assets, and phases, it is also possible to assess the maturity of the business program at other levels. For example, a maturity level can be determined for each requirement, each asset type/asset, phase, and/or for each dimension (structural and cultural). For example, for each structural and cultural dimension, the various maturity levels represent the extent to which the company has satisfied the requirements for that dimension. The meaning for the different maturity levels for the different dimensions is shown in Table 5:

TABLE 5
Maturity Meanings
Completeness of Structure (430) (for Document Asset Types)

| | |
|---|---|
| Initial | Implemented without documentation |
| Basic | Documents can be easily identified and |
| | located for use |
| Competent | Documents have standard formats and |
| | consistently use organizational terminology |
| Mastery | Latest revisions of documents are available |
| | and current |
| Innovative | There is evidence that documentation's |
| | structure and format (vs. content) is stable |
| | and continually improving |

Completeness of Structure (430) (for all other Asset Types)

| | |
|---|---|
| Initial | Implemented without documentation |
| Basic | Records of completed work exist |
| Competent | Written documentation exists about the |
| | responsibility and how this work is to be |
| | performed |
| Mastery | There is evidence of independent review |
| Innovative | There is evidence that the documentation's |
| | integrity is stable and continually improving |

Response to Structure (435)

| | |
|---|---|
| Initial | People do not know about the criterion's |
| | expectation |
| Basic | Criterion is viewed as optional; people do not |
| | seem to understand the importance of the |
| | boundary, which leads to violation |
| Competent | People accept the importance of boundaries |
| | (but may not understand why they exist) |
| Mastery | Criterion is viewed as normal; it makes |
| | sense; people exercise creativity and make |
| | good judgments because they understand the |
| | intent of boundaries |
| Innovative | People feel empowered to collaborate and |
| | improve within the intent of the criterion's |
| | boundary |

Response to Peers (440)

| | |
|---|---|
| Initial | People take direction to perform routine tasks |
| | but they do not show initiative or feel |
| | responsible for non-assigned tasks; “it's |
| | someone else's problem” is a common view |
| Basic | People feel responsible for their part of the |
| | “whole”, as they see it |
| Competent | People feel responsible, not only for their |
| | part of the “whole”, but also for their group's |
| | part |
| Mastery | People feel responsible that the entire plant |
| | performs as it should; concern expands; |
| | common expectations exist on a broader level |
| Innovative | People have moved beyond managing “what |
| | is” to proactively making things better |

Response to the External (445)

| | |
|---|---|
| Initial | People are unaware of measures, goals, or |
| | benchmarks |
| Basic | People measure things, but measures may not |
| | relate to goals or industry benchmarks |
| Competent | Goals are incentivized (based on appropriate |
| | measures) but they may not be linked to |
| | industry benchmarks |
| Mastery | Goals are measurably demonstrable against |
| | industry benchmarks |
| Innovative | Performance against measurable benchmarks |
| | qualify us as an industry leader |

Response to Leadership (450)

| | |
|---|---|
| Initial | People do not report incidents |
| Basic | People report incidents if they can assign |
| | responsibility to their leaders |
| Competent | People report incidents if they can assign |
| | responsibility to peers (or leaders) |
| Mastery | People report all incidents, including those |
| | for which they bear some responsibility |
| Innovative | People anticipate and report potential |
| | incidents |

Table 5 represents one way to assign meaning to maturity levels for each dimension. But a person skilled in the art will recognize that there are other ways in which to assign meaning to maturity levels for each dimension, and that embodiments of the invention are applicable to other meaning assignments.

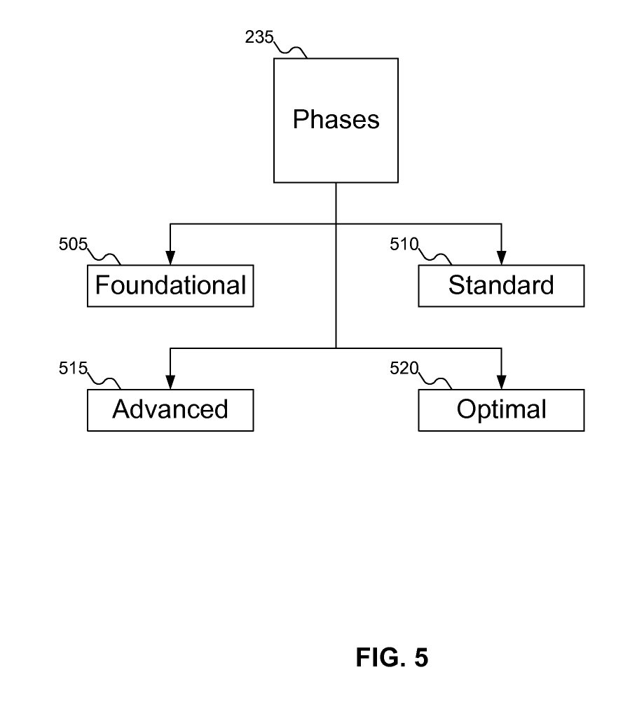

FIG. 5 shows different phases of implementing the requirements of a business program in the system of FIG. 2. As discussed above, there are four phases to implementing the requirements of a business program. These four phases are the Foundational phase (505), the Standard phase (510), the Advanced phase (515), and the Optimal phase (520).

One way to determine whether the company is in compliance with the business program can involve asking whether the company has at least reached an average of “competent” maturity level for the requirements associated with the Optimal phase (520). Further, since the maturity level of a particular phase is not determined until the previous phase of the business program is considered at least “competent”, by implication the business program will need to have reached an average of “competent” maturity levels for all requirements associated with the Foundational (505), Standard (510), and Advanced (515) phases.

In embodiments of the invention, a company needs to be considered “competent” in all four phases to be considered to have properly implemented the business program. But it is worth bearing in mind that compliance with the requirements of a business program is a voluntary act on the part of a company implementing a business program. Therefore, in other embodiments of the invention, competence can be determined using other definitions. For example, a company might consider requirements associated with the Optimal phase to be unnecessary, and that the company would be satisfied if it is considered competent through the Advanced phase. Thus, using the descriptions of the phases discussed above with reference to Table 2, to determine that the company is in compliance with the business program only requires a determination that the company is considered “competent” for the Foundational phase (505), Standard phase (510), and Advanced phase (515). In the same vein, a company might decide that the cost to implement certain requirements (which might be associated with any phase, and not just the Optimal phase) is greater than the benefit those requirements provide, and therefore the company would be willing to accept not being considered “competent” in those requirements.

To be considered “competent” for a particular phase, the implementation of the requirements for that phase might need to be considered competent. Since requirements can implicate asset types and assets (as discussed above with reference to FIG. 3, for example) as well as the different dimensions, determining whether the implementation of a business program is “competent” for some phase can require considering the assets, asset types, and dimensions associated with the requirements.

FIG. 6 shows the maturity determiner of FIG. 2 assigning a score to an asset type used to implement a requirement. In FIG. 6, maturity determiner 245 takes requirement 605, asset 610 (with an associated asset type), and dimension 615, along with user input 620, discussed below. Given these pieces of information, maturity determiner 245 can generate score 625, which reflects the maturity level for that particular requirement, asset type (of the observed asset), and dimension. These scores can be assigned sequentially: for example, a score of “1” meaning that the maturity level is “Initial”, a score of “2” meaning that the maturity level is “Basic”, a score of “3” meaning that the maturity level is “Competent”, a score of “4” meaning that the maturity level is “Mastery”, and a score of “5” meaning that the maturity level is “Innovative”. Using this scoring system enables the assessor to arithmetically calculate a number that reflects the company's overall compliance with a phase of the business program, as discussed below with reference to FIG. 7.

User input 620 reflects what persons familiar with the requirement, asset type, and dimension think about how the company is doing. The questions asked of the users, and the meanings of the possible responses, is shown for the Structural dimension in Table 6, the Structural Response dimension in Table 7, the Peer Response dimension in Table 8, the External Response dimension in Table 9, and the Leadership Response dimension in Table 10:

TABLE 6
Completeness of Structure Dimension

| Asset Types | Question | Initial | Basic | Competent | Mastery | Innovative |
|---|---|---|---|---|---|---|
| Physical | In general, | Imple- | Records | Written documen- | There is | There is evidence |
| | what evidence | mented | exist of | tation exists about | evidence | that the integrity |
| | exists of the | without | work done | the responsibility | of inde- | of documentation |
| | implementation | documen- | | and how this work is | pendent | is stable and con- |
| | of this item? | tation | | to be performed | review | tinually improving |
| Business | In general, | Imple- | Records | Written documen- | There is | There is evidence |
| | what evidence | mented | exist of | tation exists about | evidence | that the integrity |
| | exists of the | without | work done | the responsibility | of inde- | of documentation |
| | implementation | documen- | | and how this work is | pendent | is stable and con- |
| | of this item? | tation | | to be performed | review | tinually improving |
| Documents | In general, | Imple- | Documents | Documents have | Latest re- | There is evidence |
| | how well | mented | can be | standard formats | visions of | that documenta- |
| | is the item | without | easily | and consistently | documents | tion's structure and |
| | documented? | documen- | identified | use organizational | are availa- | format (vs. content) |
| | | tation | and located | terminology | ble and | is stable and con- |
| | | | for use | | current | tinually improving |
| Social | In general, | Imple- | Records | Written documen- | There is | There is evidence |
| | what evidence | mented | exist of | tation exists about | evidence | that the integrity |
| | exists that an | without | work done | the responsibility | of inde- | of documentation |
| | organization | documen- | | and how this work is | pendent | is stable and con- |
| | is accountable | tation | | to be performed | review | tinually improving |
| | for this item? | | | | | |

TABLE 7
Response to Structure Dimension

| Asset Types | Question | Initial | Basic | Competent | Mastery | Innovative |
|---|---|---|---|---|---|---|
| Physical | In general, | People | The criterion is | People accept | Criterion is viewed | People feel |
| | how do | don't know | viewed as optional; | the importance | as normal; it makes | empowered |
| | people feel | about the | people do not seem | of boundaries | sense; people can | to improve |
| | about being | criterion's | to understand the | but do not | exercise creativity | within the |
| | required to | expecta- | importance of the | understand why | and make good judg- | intent of |
| | do this | tions | boundary, leading | this partic- | ments because they | boundary of |
| | item? | | to violation | ular boundary | understand the in- | the criterion |
| | | | | exists | tent of boundaries | |
| Business | In general, | People | The criterion is | People accept | Criterion is viewed | People feel |
| | how do | don't know | viewed as optional; | the importance | as normal; it makes | empowered |
| | people feel | about the | people do not seem | of boundaries | sense; people can | to improve |
| | about being | criterion's | to understand the | but do not | exercise creativity | within the |
| | required to | expecta- | importance of the | understand why | and make good judg- | intent of |
| | do this | tions | boundary, leading | this partic- | ments because they | boundary of |
| | item? | | to violation | ular boundary | understand the in- | the criterion |
| | | | | exists | tent of boundaries | |
| Documents | In general, | People | The criterion is | People accept | Criterion is viewed | People feel |
| | how do people | don't know | viewed as optional; | the importance | as normal; it makes | empowered |
| | feel about | about the | people do not seem | of boundaries | sense; people can | to improve |
| | the level of | criterion's | to understand the | but do not | exercise creativity | within the |
| | documen- | expecta- | importance of the | understand why | and make good judg- | intent of |
| | tation rigor | tions | boundary, leading | this partic- | ments because they | boundary of |
| | required for | | to violation | ular boundary | understand the in- | the criterion |
| | this item? | | | exists | tent of boundaries | |
| Social | In general, | People | The criterion is | People accept | Criterion is viewed | People feel |
| | how do | don't know | viewed as optional; | the importance | as normal; it makes | empowered |
| | people feel | about the | people do not seem | of boundaries | sense; people can | to improve |
| | about being | criterion's | to understand the | but do not | exercise creativity | within the |
| | required to | expecta- | importance of the | understand why | and make good judg- | intent of |
| | do this | tions | boundary, leading | this partic- | ments because they | boundary of |
| | item? | | to violation | ular boundary | understand the in- | the criterion |
| | | | | exists | tent of boundaries | |

TABLE 8
Response to Peers Dimension

| Asset Types | Question | Initial | Basic | Competent | Mastery | Innovative |
|---|---|---|---|---|---|---|
| Physical | In general, | People will take | People feel | People feel re- | People respon- | People feel |
| | how do | direction to per- | responsible | sponsible that | sible that the | responsible |
| | people | form routine | for their | their group per- | entire plant per- | to make |
| | view their | tasks; they do | part of the | forms as part of | forms as it | things |
| | responsi- | not show initia- | “whole”, | the “whole”; | should; concern | better, |
| | bility for | tive, feeling | as they see | norms are being | expands; more | collabo- |
| | this item? | responsible for | it | established and | homogeneous | rating |
| | | nonassigned tasks; | | leadership can | expectations | across tra- |
| | | it's someone | | be less directive | exist on a | ditional |
| | | else's problem | | | broader level | boundaries |
| Business | In general, | People will take | People feel | People feel re- | People respon- | People feel |
| | how do | direction to per- | responsible | sponsible that | sible that the | responsible |
| | people | form routine | for their | their group per- | entire plant per- | to make |
| | view their | tasks; they do | part of the | forms as part of | forms as it | things |
| | responsi- | not show initia- | “whole”, | the “whole”; | should; concern | better, |
| | bility for | tive, feeling | as they see | norms are being | expands; more | collabo- |
| | this item? | responsible for | it | established and | homogeneous | rating |
| | | nonassigned tasks; | | leadership can | expectations | across tra- |
| | | it's someone | | be less directive | exist on a | ditional |
| | | else's problem | | | broader level | boundaries |
| Documents | In general, | People will take | People feel | People feel re- | People respon- | People feel |
| | how do | direction to per- | responsible | sponsible that | sible that the | responsible |
| | people | form routine | for their | their group per- | entire plant per- | to make |
| | view their | tasks; they do | part of the | forms as part of | forms as it | things |
| | documen- | not show initia- | “whole”, | the “whole”; | should; concern | better, |
| | tation re- | tive, feeling | as they see | norms are being | expands; more | collabo- |
| | sponsibili- | responsible for | it | established and | homogeneous | rating |
| | ties? | nonassigned tasks; | | leadership can | expectations | across tra- |
| | | it's someone | | be less directive | exist on a | ditional |
| | | else's problem | | | broader level | boundaries |
| Social | In general, | People will take | People feel | People feel re- | People respon- | People feel |
| | how do | direction to per- | responsible | sponsible that | sible that the | responsible |
| | people | form routine | for their | their group per- | entire plant per- | to make |
| | within the | tasks; they do | part of the | forms as part of | forms as it | things |
| | organiza- | not show initia- | “whole”, | the “whole”; | should; concern | better, |
| | tion view | tive, feeling | as they see | norms are being | expands; more | collabo- |
| | their re- | responsible for | it | established and | homogeneous | rating |
| | sponsibil- | nonassigned tasks; | | leadership can | expectations | across tra- |
| | ity for this | it's someone | | be less directive | exist on a | ditional |
| | item? | else's problem | | | broader level | boundaries |

TABLE 9
Response to the External Dimension

| Asset Types | Question | Initial | Basic | Competent | Mastery | Innovative |
|---|---|---|---|---|---|---|
| Physical | In general, | Unaware | Measuring | Have a goal with | The conclu- | Measur- |
| | how well | of | may or | incentives (based | sion is | able bench- |
| | do people | measures, | may not | on the measures) | measurably | marks |
| | perform | goals, or | have goal, | that support the | demonstrable | qualify us |
| | this item? | bench- | or industry | goal; may or may | against | as an in- |
| | | marks | benchmark | not have industry | industry | dustry |
| | | | | benchmark | benchmarks | leader |
| Business | In general, | Unaware | Measuring | Have a goal with | The conclu- | Measur- |
| | how well | of | may or | incentives (based | sion is | able bench- |
| | do people | measures, | may not | on the measures) | measurably | marks |
| | perform | goals, or | have goal, | that support the | demonstrable | qualify us |
| | this item? | bench- | or industry | goal; may or may | against | as an in- |
| | | marks | benchmark | not have industry | industry | dustry |
| | | | | benchmark | benchmarks | leader |
| Documents | In general, | Unaware | Measuring | Have a goal with | The conclu- | Measur- |
| | how well | of | may or | incentives (based | sion is | able bench- |
| | do people | measures, | may not | on the measures) | measurably | marks |
| | perform | goals, or | have goal, | that support the | demonstrable | qualify us |
| | this item? | bench- | or industry | goal; may or may | against | as an in- |
| | | marks | benchmark | not have industry | industry | dustry |
| | | | | benchmark | benchmarks | leader |
| Social | In general, | Unaware | Measuring | Have a goal with | The conclu- | Measur- |
| | how well | of | may or | incentives (based | sion is | able bench- |
| | do peo- | measures, | may not | on the measures) | measurably | marks |
| | ple/organi- | goals, or | have goal, | that support the | demonstrable | qualify us |
| | zation per- | bench- | or industry | goal; may or may | against | as an in- |
| | form this | marks | benchmark | not have industry | industry | dustry |
| | item? | | | benchmark | benchmarks | leader |

TABLE 103
Response to Leadership Dimension

| Asset Types | Question | Initial | Basic | Competent | Mastery | Innovative |
|---|---|---|---|---|---|---|
| Physical | In general, | People do | People re- | People re- | People re- | People an- |
| | how do | not report | port inci- | port inci- | port all | ticipate |
| | people re- | incidents | dents if | dents if | incidents, | and report |
| | spond to | | they can | they can | including | potential |
| | failures to | | assign re- | assign re- | those for | incidents |
| | meet this | | sponsibil- | sponsibil- | which they | |
| | item? | | ity to their | ity to peers | bear some | |
| | | | leaders | (or leaders) | responsi- | |
| | | | | | bility | |
| Business | In general, | People do | People re- | People re- | People re- | People an- |
| | how do | not report | port inci- | port inci- | port all | ticipate |
| | people re- | incidents | dents if | dents if | incidents, | and report |
| | spond to | | they can | they can | including | potential |
| | failures to | | assign re- | assign re- | those for | incidents |
| | meet this | | sponsibil- | sponsibil- | which they | |
| | item? | | ity to their | ity to peers | bear some | |
| | | | leaders | (or leaders) | responsi- | |
| | | | | | bility | |
| Documents | In general, | People do | People re- | People re- | People re- | People an- |
| | how do | not report | port inci- | port inci- | port all | ticipate |
| | people re- | incidents | dents if | dents if | incidents, | and report |
| | spond to | | they can | they can | including | potential |
| | failures of | | assign re- | assign re- | those for | incidents |
| | documen- | | sponsibil- | sponsibil- | which they | |
| | tation re- | | ity to their | ity to peers | bear some | |
| | garding | | leaders | (or leaders) | responsi- | |
| | this item? | | | | bility | |
| Social | In general, | People do | People re- | People re- | People re- | People an- |
| | how do | not report | port inci- | port inci- | port all | ticipate |
| | people in | incidents | dents if | dents if | incidents, | and report |
| | this posi- | | they can | they can | including | potential |
| | tion re- | | assign re- | assign re- | those for | incidents |
| | spond to | | sponsibil- | sponsibil- | which they | |
| | failures to | | ity to their | ity to peers | bear some | |
| | meet this | | leaders | (or leaders) | responsi- | |
| | item? | | | | bility | |

Table 6, Table 7, Table 8, Table 9, and Table 10 represent one way to interpret how mature a business program is with respect to different dimensions and asset types. But a person skilled in the art will recognize that there are other ways to interpret how mature a business program is with respect to different dimensions and asset types, and that embodiments of the invention are applicable to other interpretations.

So, for example, if a user thinks that the company has adequate written documentation about the responsibilities associated with a physical asset type, the user can answer “3” (or “Competent”) to a question about the completeness of the physical structure with respect to a particular business program. If that same user thinks that the physical documentation exists, but are not yet in a standardized format, that user can answer “2” (or “Basic”) to a question about the completeness of the documentation structure with respect to a particular business program.

Although the above description suggests that only one user is asked for their input, the number of users queried for their input can vary, depending on the situation. For example, it might be that only one user is qualified to state the maturity level of the company for one requirement/asset type/dimension, but a whole team might be qualified to state the maturity level of the company for another requirement/asset type/dimension. By having as many people as possible provide input, the more likely it is that the results are accurate: that is, whether the company is actually in compliance with the business program. After all, if only one user provides input, the results will be very heavily skewed by that user's biases.

By obtaining user input for each requirement, asset type, and dimension, a significant amount of data can be obtained about the status of a business program. This data can then be mined to various purposes. For example, graphs can be generated comparing any of the information in the system (requirements, asset types, phases, structural and cultural dimensions, and scores representing the maturity of the asset type for the given requirement, phase, and dimension). These graphs can be of use to the company to see how the company is doing toward compliance with the business program. These graphs can also be limited to a subset of values in any of the information, if useful: for example, the company might be interested in seeing its progress only in the Foundational and Standard phases.

Among the data that can be mined from this information is whether the company is in compliance with the business program. One way to determine whether a company is in compliance with a business program is to determine if the company has achieved a maturity level of “competent” in the Optimal phase. But as discussed above, it is possible to decide whether a company is in compliance with a business program using other criteria. For example, compliance can be determined by considering all of the information for all phases of the business program. FIG. 7 illustrates this possibility. In FIG. 7 the assessor of FIG. 2 uses maturity scores to determine if a company is in compliance with a business program. Assessor 250 can take scores 625-1 through 625-n from various maturity determinations. These scores 625-1 through 625-n can then be combined to produce result 705 to determine if the company is in compliance with the business program.

There are several different ways in which scores 625-1 through 625-n can be combined. One possibility is to calculate the average (arithmetic mean) of scores 625-1 through 625-n. If taken over the entire population of scores 625-1 through 625-n (without regard to requirement, asset type, dimension, or phase), then an overall average score can be calculated. Using the earlier example of scoring “1” for “Initial” maturity through “5” for “Innovative” maturity, an average score of “3” would represent competence, which is the target for determining corporate compliance. Thus, if the average score is at least “3”, then result 705 would indicate that the company is in compliance with the business program.

In general, however, it is less meaningful to compute an overall average across phases than to compute averages for each dimension and each phase (but including all requirements and asset types for each dimension/phase). Such a more focused analysis can be more insightful, as it examines each combination of dimension and phase as a whole, which helps to reveal how a company is progressing in each dimension. Thus, for example, the average might be 3.2 in the Structural dimension, but only 1.8 in the Leadership Response dimension, which indicates that the structural assets are in place, but leadership is still lacking.

As an alternative to computing the average of scores 625-1 through 625-n, assessor 250 can select the minimum score among scores 625-1 through 625-n. Such an approach is necessarily stricter in its calculation, since the average will exceed the minimum value (except in the boundary condition where every value is the minimum value). But by using the minimum score, a company can see exactly where the weaknesses lie: a minimum score of “2” indicates that, for some combination of requirement, asset type, and dimension, the company is not yet considered competent.

Where a score is computed not over all scores but rather over individual subsets (e.g., for a given combination of a dimension/phase), these computed scores can then be combined in any desired manner to compute an overall score for the business program.

Although the average (arithmetic mean) and minimum are presented above as examples of how to determine a result, a person of ordinary skill will recognize that any desired mathematical model can be used to determine a result. In addition, combinations of mathematical models can be used. For example, the average score for a combination of dimension/phase can be computed, but then the minimum of those average scores can be used to make the final determination as to whether the company is in compliance with the business program.

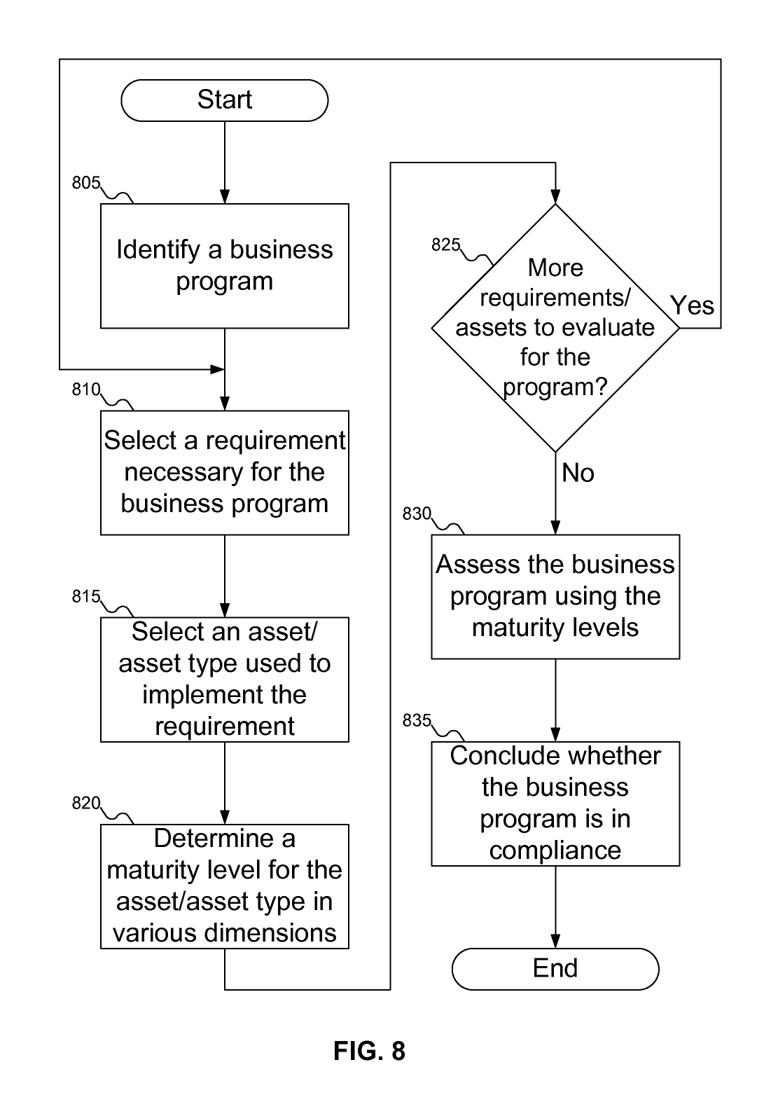

FIG. 8 shows a flowchart of a procedure to determine if a company is in compliance with a business program, according to an embodiment of the invention. In block 805, a business program is identified. In block 810, a specific requirement of the business program is selected. At block 815, a specific asset/asset type for the selected requirement is selected. (A person of ordinary skill in the art will recognize that selecting a specific asset necessarily identifies a specific asset type, since each asset is associated with only one asset type.) As discussed above, there can be a many-to-many relationship between requirements and asset types. Thus, a given requirement might be evidenced by only one asset type (and one or more assets of that asset type), or it might be evidenced by many asset types (and many assets of those asset types); similarly, an asset type might provide evidence for one or many requirements.

At block 820, a maturity level is determined for the selected requirement and the selected asset/asset type in the various dimensions. Block 820 does not require that a maturity level be determined for the selected requirement and the selected asset/asset type in every dimension. For example, if only one dimension is being analyzed at a particular point in time, then the maturity level of the selected requirement and the selected asset/asset type only needs to be determined for that one dimension. At decision point 825, the system determines if there are more requirements (or assets that can provide evidence of the requirement) of the business program to consider. If so, then control returns to block 810 to select another requirement (or to re-select the same requirement) of the business program. Note that decision point 825 does not require returning to block 810 to ensure that the maturity level of every requirement/asset/dimension is required; decision point 825 only considers whether there are more requirements/assets/dimensions whose maturity level need to be determined at this time. Otherwise, control continues with block 830, where the business program as a whole is assessed based on the maturity levels. As discussed above, there are many different ways to determine the maturity of the business program as a whole. In addition, as discussed above, rather than assessing the business program as a whole, a subset of the business program (for example, an individual phase, or a combination of a dimension/phase) can be assessed. Finally, at block 835, it can be concluded whether the company is in compliance with the business program (or, if only a subset of the business program is being analyzed—such as a particular phase or a particular dimension—whether the company is in compliance with the business program with respect to that subset of the business program).

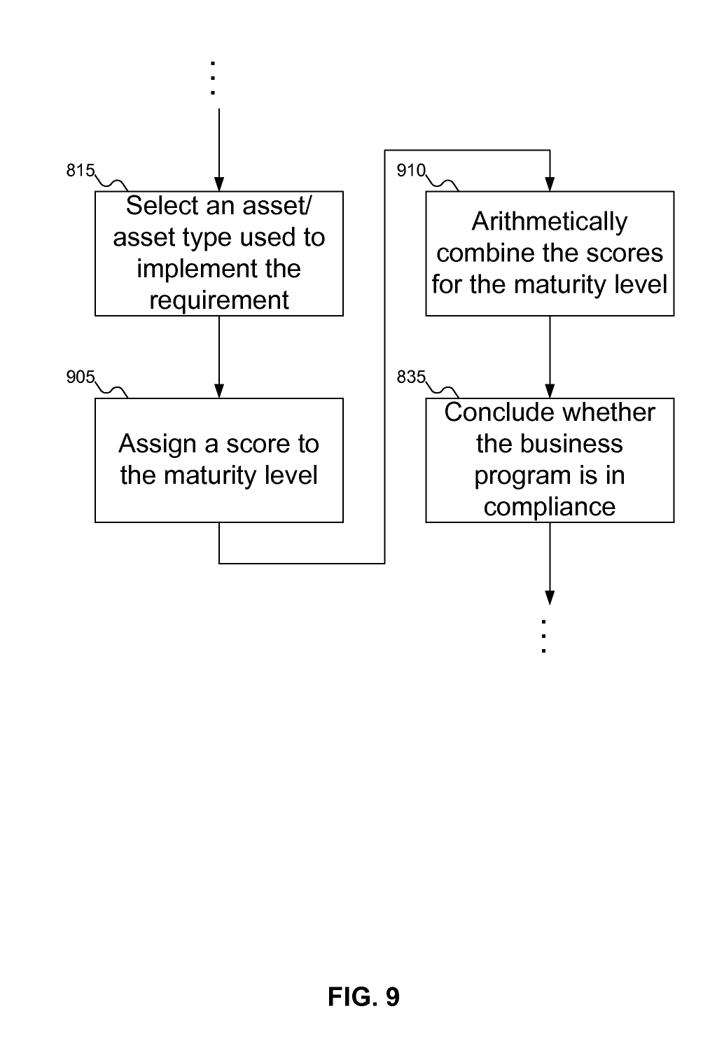

As discussed above with reference to FIG. 7, there are different mathematical models that can be used to determine whether the company is in compliance with the business program. FIG. 9 shows details of how the system of FIG. 2 can determine if a company is in compliance with a business program in the flowchart of FIG. 8. In FIG. 9, blocks 820 and 830 are altered by blocks 905 and 910, respectively. In block 905, a score is assigned to a maturity level, and at block 910, the scores are arithmetically combined. The combined score can then be used in block 835 to determine if the program is in compliance with the business program.

The following discussion is intended to provide a brief, general description of a suitable machine in which certain aspects of the invention may be implemented. Typically, the machine includes a system bus to which is attached processors, memory, e.g., random access memory (RAM), read-only memory (ROM), or other state preserving medium, storage devices, a video interface, and input/output interface ports. The machine may be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, or a system of communicatively coupled machines or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine may include embedded controllers, such as programmable or non-programmable logic devices or arrays, Application Specific Integrated Circuits, embedded computers, smart cards, and the like. The machine may utilize one or more connections to one or more remote machines, such as through a network interface, modem, or other communicative coupling. Machines may be interconnected by way of a physical and/or logical network, such as an intranet, the Internet, local area networks, wide area networks, etc. One skilled in the art will appreciated that network communication may utilize various wired and/or wireless short range or long range carriers and protocols, including radio frequency (RF), satellite, microwave, any of the Institute of Electrical and Electronics Engineers (IEEE) 810.11 standards, Bluetooth, optical, infrared, cable, laser, etc.

The invention may be described by reference to or in conjunction with associated data including functions, procedures, data structures, application programs, etc. which when accessed by a machine results in the machine performing tasks or defining abstract data types or low-level hardware contexts. Associated data may be stored in, for example, the volatile and/or non-volatile memory, e.g., RAM, ROM, etc., or in other non-transitory storage devices and their associated storage media, including hard-drives, floppy-disks, optical storage, tapes, flash memory, memory sticks, digital video disks, biological storage, etc.: such associated data, by virtue of being stored on a storage medium, does not include propagated signals. Associated data may be delivered over transmission environments, including the physical and/or logical network, in the form of packets, serial data, parallel data, propagated signals, etc., and may be used in a compressed or encrypted format. Associated data may be used in a distributed environment, and stored locally and/or remotely for machine access.

Having described and illustrated the principles of the invention with reference to illustrated embodiments, it will be recognized that the illustrated embodiments may be modified in arrangement and detail without departing from such principles. And, though the foregoing discussion has focused on particular embodiments, other configurations are contemplated. In particular, even though expressions such as “in one embodiment” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

What is claimed is:

1. A system, comprising:
a computer;
a set of requirements, stored in the computer, the set of requirements necessary to implement a business program;
a set of asset types, stored in the computer, the set of asset types used to implement the set of requirements;
a maturity determiner to determine a maturity level for at least one asset with an asset type with respect to at least one requirement in a plurality of dimensions including at least a structural dimension and a cultural dimension; and
an assessor to assess the business program based on said maturity level for said at least one asset with said asset type.

2. A system according to claim 1, wherein said plurality of dimensions includes the structural dimension, a response to structure dimension, a response to peers dimension, a response to the external dimension, and a response to leadership dimension.

3. A system according to claim 1, wherein:
the system further comprises at least two different phases stored in the computer; and
each requirement in the set of requirements is associated with a phase in the at least two different phases,
wherein at least a first requirement is associated with a first phase and a second requirement is associated with a second phase and no requirement is associated with two phases.

4. A system according to claim 3, wherein the at least two different phases includes a foundational phase, a standard phase, an advanced phase, and an optimal phase.

5. A system according to claim 3, wherein:
the maturity determiner is operative to assign a score to the maturity level for said at least one asset with the asset type with respect to at least one requirement in each of the plurality of dimensions; and
the assessor is operative to arithmetically combine, for each phase in a subset of the at least two different phases, the scores for each of the plurality of dimensions.

6. A system according to claim 5, wherein the assessor is further operative to conclude that the business is in compliance if said arithmetic combination of said scores for each of the plurality of dimensions in each phase of the subset of the at least two different phases reflects at least competence.

7. A method, comprising:
identifying a business program for a business using a computer;
selecting a requirement necessary to implement the business program;
selecting an asset type to implement the requirement;
determining at least one maturity level for an asset with the asset type with respect to at least one requirement in a plurality of dimensions including at least a structural dimension and a cultural dimension; and
assessing the business program based on the maturity level for the asset with the asset type.

8. A method according to claim 7, wherein determining at least one maturity level for an asset with the asset type with respect to at least one requirement in a plurality of dimensions including at least a structural dimension and a cultural dimension includes determining the at least one maturity level for the asset with the asset type with respect to the at least one requirement in the structural dimension, a response to structure dimension, a response to peers dimension, a response to the external dimension, and a response to leadership dimension.

9. A method according to claim 7, wherein:
selecting an asset type to implement the requirement includes selecting a plurality of asset types to implement the requirement;
determining a maturity level for an asset with the asset type with respect to at least one requirement includes determining maturity levels for assets with each of the plurality of asset types with respect to the at least one requirement in the plurality of dimensions.

10. A method according to claim 9, wherein selecting a requirement necessary to implement the business program includes selecting a plurality of requirements necessary to implement the business program.

11. A method according to claim 10, wherein selecting a plurality of requirements necessary to implement the business program includes selecting the plurality of requirements necessary to implement a first phase of the business program, wherein the first phase is one of at least two different phases, at least the first phase and a second phase of the at least two different phases include requirements necessary to implement the first phase and the second phase, and no requirement is associated with two phases.

12. A method according to claim 11, wherein selecting the plurality of requirements necessary to implement a first phase of the business program, includes selecting the plurality of requirements necessary to implement the first phase of the business program, wherein the first phase of the business program is drawn from a set including a foundational phase, a standard phase, an advanced phase, and an optimal phase.

13. A method according to claim 11, wherein determining maturity levels for assets with each of the plurality of asset types with respect to the at least one requirement in the plurality of dimensions includes determining the maturity levels for assets with each of the plurality of asset types for each of the plurality of requirements necessary to implement the first phase of the business program in the plurality of dimensions.

14. A method according to claim 13, wherein:
determining the maturity levels for assets with each of the plurality of asset types for each of the plurality of requirements necessary to implement the first phase of the business program in the plurality of dimensions includes assigning scores to the maturity levels for each of the assets with each of the plurality of asset types for each of the plurality of requirements necessary to implement the first phase of the business program in each of the plurality of dimensions; and
assessing the business program includes, for each phase in a subset of the at least two different phases, arithmetically combining the scores.

15. A method according to claim 14, wherein assessing the business program further includes concluding that the business is in compliance if the arithmetic combination of the scores for each of the plurality of dimensions in each phase of the subset of the at least two different phases reflects at least competence.

16. An article, comprising a non-transitory storage medium, said non-transitory storage medium having stored thereon instructions that, when executed by a machine, result in:
identifying a business program for a business using a computer;
selecting a requirement necessary to implement the business program;
selecting an asset type to implement the requirement;
determining at least one maturity level for an asset with the asset type with respect to at least one requirement in a plurality of dimensions including at least a structural dimension and a cultural dimension; and
assessing the business program based on the maturity level for the asset with the asset type.

17. An article according to claim 16, wherein determining at least one maturity level for an asset with the asset type with respect to at least one requirement in a plurality of dimensions including at least a structural dimension and a cultural dimension includes determining the at least one maturity level for the asset with the asset type with respect to the at least one requirement in the structural dimension, a response to structure dimension, a response to peers dimension, a response to the external dimension, and a response to leadership dimension.

18. An article according to claim 16, wherein:
selecting an asset type to implement the requirement includes selecting a plurality of asset types to implement the requirement;
determining a maturity level for an asset with the asset type with respect to at least one requirement includes determining maturity levels for assets with each of the plurality of asset types with respect to the at least one requirement in the plurality of dimensions.

19. An article according to claim 18, wherein selecting a requirement necessary to implement the business program includes selecting a plurality of requirements necessary to implement the business program.

20. An article according to claim 19, wherein selecting a plurality of requirements necessary to implement the business program includes selecting the plurality of requirements necessary to implement a first phase of the business program, wherein the first phase is one of at least two different phases, at least the first phase and a second phase of the at least two different phases include requirements necessary to implement the first phase and the second phase, and no requirement is associated with two phases.

21. An article according to claim 20, wherein selecting the plurality of requirements necessary to implement a first phase of the business program, includes selecting the plurality of requirements necessary to implement the first phase of the business program, wherein the first phase of the business program is drawn from a set including a foundational phase, a standard phase, an advanced phase, and an optimal phase.

22. An article according to claim 20, wherein determining maturity levels for assets with each of the plurality of asset types with respect to the at least one requirement in the plurality of dimensions includes determining the maturity levels for assets with each of the plurality of asset types for each of the plurality of requirements necessary to implement the first phase of the business program in the plurality of dimensions.

23. An article according to claim 22, wherein:
determining the maturity levels for assets with each of the plurality of asset types for each of the plurality of requirements necessary to implement the first phase of the business program in the plurality of dimensions includes assigning scores to the maturity levels for each of the assets with each of the plurality of asset types for each of the plurality of requirements necessary to implement the first phase of the business program in each of the plurality of dimensions; and
assessing the business program includes, for each phase in a subset of the at least two different phases, arithmetically combining the scores.

24. An article according to claim 23, wherein assessing the business program further includes concluding that the business is in compliance if the arithmetic combination of the scores for each of the plurality of dimensions in each phase of the subset of the at least two different phases reflects at least competence.
